(19) United States
(12) Patent Application Publication
(10) Pub. No.: US 2026/0255133 A1
(43) Pub. Date: Aug. 27, 2026

(54) LOCATION IDENTIFICATION SYSTEM AND LOCATION IDENTIFICATION APPARATUS

(71) Applicant: ISUZU MOTORS LIMITED, Yokohama-shi (JP)

(72) Inventor: Tatsuya NAGAOKA, Fujisawa-shi (JP)

(21) Appl. No.: 19/438,730

(22) Filed: Jan. 2, 2026

(30) Foreign Application Priority Data
Feb. 21, 2025 (JP) 2025-026676

(51) Int. Cl. H04W 4/029; G06Q 10/083

(52) U.S. Cl. CPC H04W 4/029; G06Q 10/083

(57) ABSTRACT

A first device attached to a package transmits a MAC address of a first access point of the vehicle and a device ID to a location identification apparatus. An in-vehicle apparatus transmits the MAC address of the first access point and a position of the vehicle to the location identification apparatus. When the MAC addresses of the first device and the in-vehicle apparatus are the same, the location identification apparatus stores a position of the first access point as a position of the first device, and transmits a transmission stop instruction for the same MAC address to the first device.

### CROSS-REFERENCE TO RELATED APPLICATIONS

The present application claims priority to Japanese Patent Applications No.2025- 26676, filed on February 21, 2025, contents of which are incorporated herein by reference in their entirety.

### BACKGROUND OF THE INVENTION

The present disclosure relates to a location identification system and a location identification apparatus for identifying a location of a package. A technique for identifying a location of a package is known. Japanese Unexamined Patent Application Publication No. 2021-533052 discloses a technique in which a sensor module, which is attached to a shipping box accommodating packages and includes a global positioning system (GPS) sensor, transmits location information of the location measured by the GPS sensor to an external device.

However, in order to appropriately identify the location of the package, it is necessary for the sensor module to transmit location information to the external device more frequently, which leads to an increase in the power consumption of the sensor module.

### BRIEF SUMMARY OF THE INVENTION

Therefore, the present disclosure has been made in view of these points, and an object of the present disclosure is to achieve both identification of a location of a package and reduction of power consumption.

A first aspect of the present disclosure provides a location identification system including: a device attached to a package transported by a vehicle; a transmission apparatus that transmits self-location information; and an external device that acquires information from the device and the transmission apparatus, wherein the device includes: a first acquisition unit that acquires first identification information of one wireless device capable of wirelessly communicating with the device; and a first transmission control unit that transmits the acquired first identification information and device identification information of the device to the external device in association with each other, the transmission apparatus includes: a second transmission control unit that transmits second identification information of one wireless device and the self-location information indicating a position associated with the one wireless device to the external device, the external device includes: a second acquisition unit that acquires the first identification information and the device identification information transmitted from the device, and the second identification information and the self-location information transmitted from the transmission apparatus; a storage control unit that causes a storage unit to store a position indicated by the self-location information as a position of the device, when the first identification information and the second identification information are the same; and a third transmission control unit that transmits, to the device, an instruction to stop the first transmission control unit from transmitting the first identification information acquired by the first acquisition unit to the external device, when the first identification information and the second identification information are the same, and the first transmission control unit stops transmitting the first identification information to the external device when the instruction is received from the external device.

A second aspect of the present disclosure provides a location identification apparatus including: an acquisition unit that acquires, from a device attached to a package transported by a vehicle, (i) first identification information of one wireless device capable of wirelessly communicating with the device and (ii) device identification information of the device that transmits the first identification information and the device identification information in association with each other, and acquires second identification information of the one wireless device and self-location information indicating a position associated with the one wireless device from a transmission apparatus that transmits the second identification information and the self-location information; a storage control unit that causes a storage unit to store a position indicated by the self-location information as a position of the device when the first identification information and the second identification information are the same; and a transmission control unit that transmits, to the device, a stop instruction to stop transmission of the first identification information acquired by the acquisition unit when the first identification information and the second identification information are the same.

### BRIEF DESCRIPTION OF THE DRAWINGS

FIG. 1 is a diagram for explaining an overview of a location identification system.

FIG. 2 is a diagram illustrating a configuration of the location identification system.

FIG. 3 is an example of a data table in which a device ID and a MAC address are associated with each other.

FIG. 4 is an example of a data table in which a MAC address and location information are associated with each other.

FIG. 5 is an example of a data table in which a device ID is associated with location information.

FIG. 6 is a data table in which a MAC address is associated with a device ID.

FIG. 7 is a sequence diagram showing a process flow of identifying a location of a package.

FIG. 8 is a sequence diagram showing a process flow of stopping acquisition of MAC addresses.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### Overview of a location identification system S

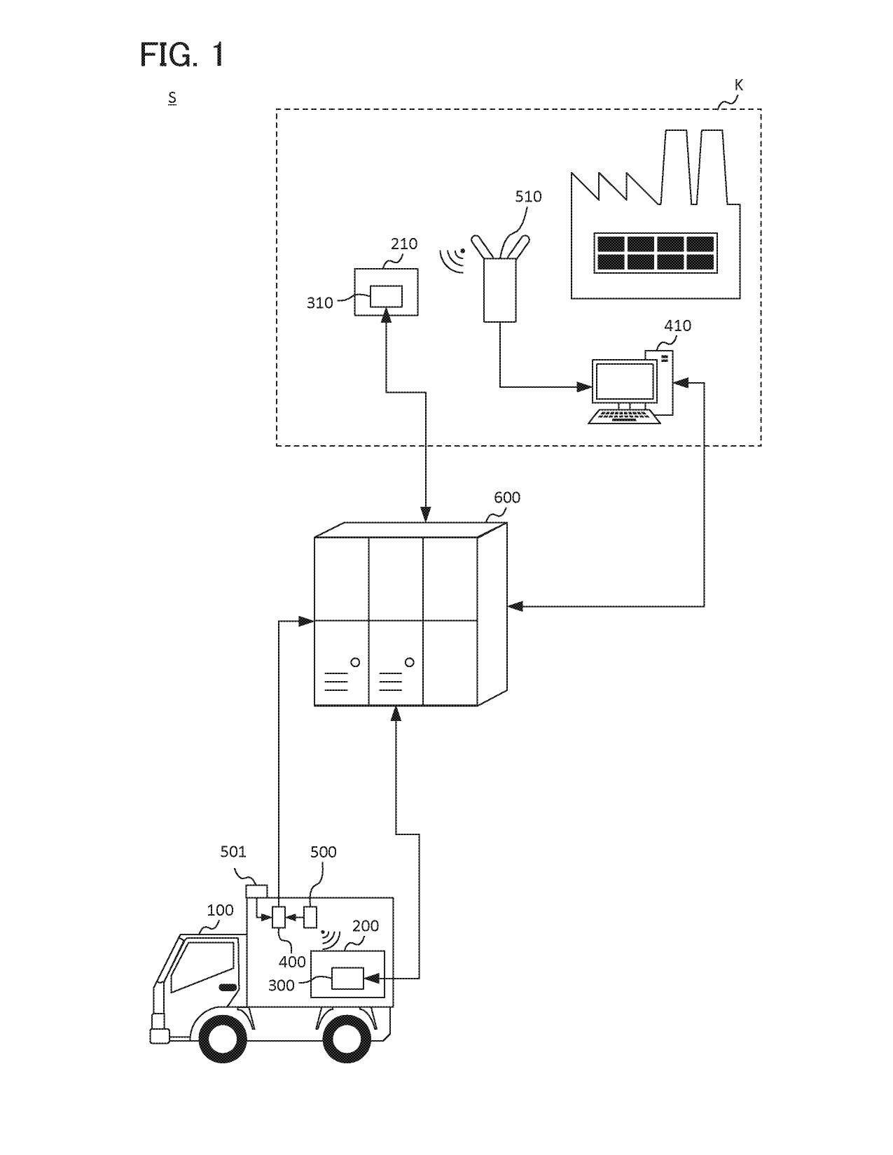

FIG. 1 is a diagram for explaining an overview of a location identification system S. The location identification system S is a system that identifies locations of a package 200 and a package 210 transported by a vehicle 100. The location identification system S includes a first device 300, a second device 310, an in-vehicle apparatus 400, a base terminal 410, a first access point 500, a second access point 510, and a location identification apparatus 600.

The vehicle 100 transports at least one of the package 200 or the package 210. The vehicle 100 is, for example, a truck or a trailer, but is not limited thereto. The vehicle 100 transports the package 200 to a delivery base K or transports the package 210 stored in the delivery base K to a destination. The delivery base K is a facility that receives the package 200 and ships it to another destination, or stores the package 210 until it is shipped to a destination. The delivery base K may be a factory, an office, or the like. The vehicle 100 is equipped with a first access point 500, a GPS (Global Positioning System) receiver 501, and the in-vehicle apparatus 400.

The first access point 500 is a wireless device provided in a cargo space of the vehicle 100. The first access point 500 may communicate with another apparatus using wireless communication. The first access point 500 is, for example, a base station of Wi-Fi (registered trademark), but is not limited thereto. The first access point 500 transmits a MAC (Media Access Control) address of the first access point 500 to another apparatus that can wirelessly communicate with the first access point 500. Specifically, the first access point 500 transmits the MAC address of the first access point 500 to the first device 300 attached to the package 200 mounted on the vehicle 100 and the in-vehicle apparatus 400 using wireless communication. The first access point 500 may be provided in a cabin of the vehicle 100.

The GPS receiver 501 receives radio waves transmitted from GPS satellites, and identifies, at a predetermined interval, coordinates (latitude and longitude) indicating the current position of the vehicle 100. The predetermined interval is, for example, one minute, but is not limited thereto.

The in-vehicle apparatus 400 is a transmission apparatus that transmits self-location information to the location identification apparatus 600. The in-vehicle apparatus 400 is capable of wirelessly communicating with the first access point 500 and the location identification apparatus 600. The in-vehicle apparatus 400 acquires, from the first access point 500, the MAC address of the first access point 500. In addition, the in-vehicle apparatus 400 acquires the current position of the vehicle 100 identified by the GPS receiver 501. The in-vehicle apparatus 400 transmits, in association with each other, (i) the current position of the vehicle 100 and (ii) the MAC address of the first access point 500 to the location identification apparatus 600.

The first device 300 is attached to the package 200 in the cargo space of the vehicle 100. The first device 300 is capable of wirelessly communicating with the first access point 500 and the location identification apparatus 600. The first device 300 acquires the MAC address of the first access point 500 installed in the cargo space of the vehicle 100 from the first access point 500 via wireless communication. The first device 300 transmits the acquired MAC address of the first access point 500 to the location identification apparatus 600.

The second access point 510 is a wireless device similar to the first access point 500, and is a Wi-Fi base station. The second access point 510 is provided at the delivery base K. The second access point 510 transmits a MAC address of the second access point 510 to another apparatus that can wirelessly communicate with the second access point 510. Specifically, the second access point 510 transmits, using wireless communication, the MAC address of the second access point 510 to (i) the second device 310 attached to the package 210 stored at the delivery base K and (ii) the base terminal 410 installed at the delivery base K. Communication between the second access point 510 and the base terminal 410 may be wired communication.

The base terminal 410 is a computer provided at the delivery base K, and is a transmission apparatus that transmits self-location information to the location identification apparatus 600. The base terminal 410 acquires, from the second access point 510, the MAC address of the second access point 510 connected to the base terminal 410. The base terminal 410 acquires a position of the delivery base K. For example, the base terminal 410 acquires the position of the delivery base K by receiving an input of the position of the delivery base K from a user who uses the base terminal 410. The base terminal 410 transmits, in association with each other, the acquired position of the delivery base K and the MAC address of the second access point 510 to the location identification apparatus 600.

The second device 310 is attached to the package 210 stored in the delivery base K. The second device 310 can wirelessly communicate with the second access point 510 and the location identification apparatus 600. The second device 310 acquires a MAC address of the second access point 510 of the delivery base K from the second access point 510 via wireless communication. The second device 310 transmits the acquired MAC address of the second access point 510 to the location identification apparatus 600.

The first device 300 and the second device 310 acquire MAC addresses from access points with which they can wirelessly communicate. Therefore, for example, it can be said that the position of the access point having the same MAC address as the MAC address transmitted by the first device 300 is the location of the package 200 to which the first device 300 is attached. Similarly, the position of the access point having the same MAC address as the MAC address transmitted by the second device 310 is the location of the package 210 to which the second device 310 is attached.

Therefore, the location identification apparatus 600 sets the position of the access point having the same MAC address as the MAC address transmitted by each of the first device 300 and the second device 310 as the position of each of the first device 300 and the second device 310. For example, when the MAC address transmitted from the first device 300 and

the MAC address transmitted from the in-vehicle apparatus 400 are the same, the location identification apparatus 600 stores the current position of the vehicle 100, which was transmitted from the in-vehicle apparatus 400, as the location of the package 200. Similarly, when the MAC address transmitted from the second device 310 and the MAC address transmitted from the base terminal 410 are the same, the location identification apparatus 600 stores the position of the delivery base K, which was transmitted by the base terminal 410, as the location of the package 210. In this way, the location identification apparatus 600 can identify the location of the package 200 being transported in the vehicle 100 and the location of the package 210 stored at the delivery base K.

The first device 300 consumes power when transmitting the MAC address to the location identification apparatus 600. When the power consumption of the first device 300 increases, it is necessary to replace a battery for driving the first device 300 or replace the first device 300 itself. Therefore, after storing the current position of the vehicle 100 as the location of the package 200, the location identification apparatus 600 transmits, to the first device 300, a transmission stop instruction for stopping transmission of the MAC address to the location identification apparatus 600. When the transmission stop instruction is received, the first device 300 stops the transmission of the MAC address of the first access point 500 to the location identification apparatus 600 until a MAC address different from the MAC address of the first access point 500 is acquired. With this configuration, the first device 300 does not transmit a MAC address to the location identification apparatus 600 until, for example, after it has been unloaded from the vehicle 100 at the delivery base K and receives a MAC address from the second access point 510 of the delivery base K. As a result, power consumption can be reduced.

After transmitting the transmission stop instruction to the first device 300, the location identification apparatus 600 continues to acquire the current position of the vehicle 100 from the in-vehicle apparatus 400. Upon each acquisition of the current position of the vehicle 100, the location identification apparatus 600 stores the current position of the vehicle 100 as the location of the package 200. Accordingly, the location identification apparatus 600 can identify the location of the package 200 to which the first device 300 is attached, without communicating with the first device 300. As a result, the location identification system S can achieve both identification of the location of the package 200 to which the first device 300 is attached and reduction of power consumption of the first device 300.

### Configuration of the location identification System S

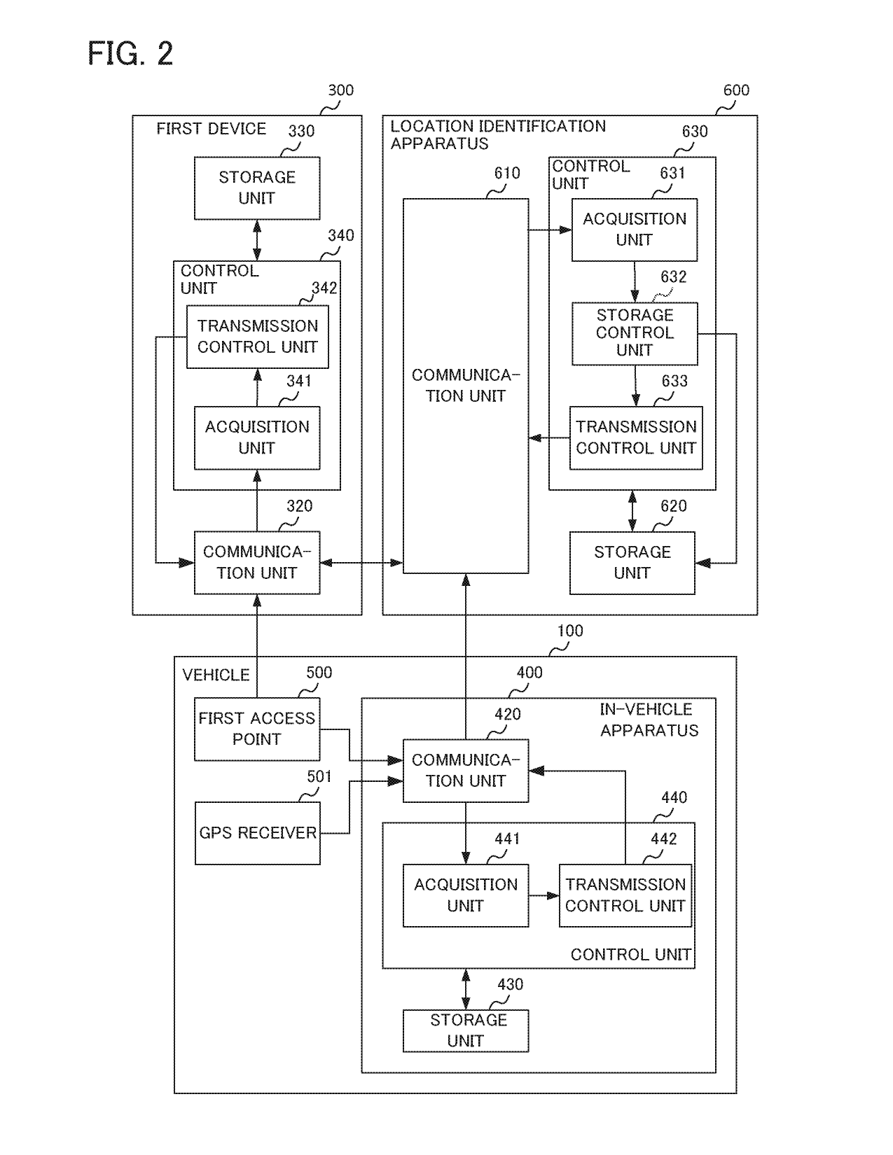

Hereinafter, a specific configuration of the location identification system S will be described with reference to FIG. 2. FIG. 2 is a diagram for explaining the configuration of the location identification system S. Since the configurations of the first device 300 and the second device 310 are the same, the configuration of the first device 300 will be described, and the description of the configuration of the second device 310 will be omitted. Similarly, since the configurations of the in-vehicle apparatus 400 and the base terminal 410 are the same, the configuration of the in-vehicle apparatus 400 will be described, and the description of the configuration of the base terminal 410 will be omitted.

The first device 300 includes a communication unit 320, a storage unit 330, a control unit 340, and a battery (not illustrated) for driving the first device 300. The communication unit 320 is a wireless communication module for transmitting and receiving information using wireless communication. The communication unit 320 can receive information from the first access point 500 using, for example, Wi-Fi. The wireless communication module receives the MAC address transmitted by the first access point 500 from the first access point 500. In addition, the wireless communication module may transmit and receive information to and from the location identification apparatus 600 using a mobile phone network. The mobile phone network is, for example, a fourth generation mobile communication system or a fifth generation mobile communication system, but is not limited thereto.

The storage unit 330 is a storage medium including a read only memory (ROM), a random access memory (RAM), a hard disk, and the like. The storage unit 330 stores a program executed by the control unit 340. The control unit 340 is a calculation resource including a processor such as a central processing unit (CPU). The control unit 340 implements functions of an acquisition unit 341 and a transmission control unit 342 by executing the program stored in the storage unit 330.

The acquisition unit 341 is a first acquisition unit that acquires a MAC address from the first access point 500 via the communication unit 320. The acquisition unit 341 acquires the MAC address from the first access point 500 at a predetermined interval. The predetermined interval is, for example, one minute, but is not limited thereto.

The transmission control unit 342 is a first transmission control unit that transmits information to the location identification apparatus 600 via the communication unit 320. The transmission control unit 342 transmits the acquired MAC address and a device ID to the location identification apparatus 600. The device ID is device identification information for identifying the first device 300. Specifically, the transmission control unit 342 transmits the acquired MAC address as first identification information to the location identification apparatus 600 in association with the device ID. More specifically, upon each acquisition of the MAC address (i.e., every one minute), the transmission control unit 342 transmits the acquired MAC address as the first identification information to the location identification apparatus 600 in association with the device ID.

The in-vehicle apparatus 400 is mounted on the vehicle 100 that transports the package 200. The in-vehicle apparatus 400 includes a communication unit 420, a storage unit 430, and a control unit 440. The communication unit 420 is a wireless communication module for transmitting and receiving information using wireless communication. The communication unit 420 can receive information from the first access point 500 using, for example, Wi-Fi, and can transmit and receive information to and from the location identification apparatus 600 using a mobile phone network.

The storage unit 430 is a storage medium including a ROM, a RAM, a hard disk, and the like. The storage unit 430 stores a program executed by the control unit 440. The control unit 440 is a calculation resource including a processor such as a CPU. The control unit 440 implements functions of an acquisition unit 441 and a transmission control unit 442 by executing the program stored in the storage unit 430.

The acquisition unit 441 is a third acquisition unit that acquires a MAC address from the first access point 500 via the communication unit 420. Specifically, the acquisition unit 441 acquires the MAC address of the first access point 500 from the first access point 500, using Wi-Fi. The acquisition unit 441 provides the acquired MAC address to the transmission control unit 442.

The acquisition unit 441 acquires the current position of the vehicle 100 on which the in-vehicle apparatus 400 is mounted. The acquisition unit 441 acquires, from the GPS receiver 501, the current position of the vehicle 100 identified by the GPS receiver 501. Each time the GPS receiver 501 identifies the current position, the acquisition unit 441 acquires the identified current position and provides the transmission control unit 442 with self-location information indicating the identified current position.

The transmission control unit 442 is a second transmission control unit that transmits, in association with each other, the acquired MAC address and the provided self-location information to the location identification apparatus 600, using wireless communication. Specifically, the transmission control unit 442 transmits the acquired MAC address as second identification information to the location identification apparatus 600 via the communication unit 420 in association with the self-location information indicating the current position of the vehicle 100. Upon each acquisition of the self-location information (that is, every one minute), the transmission control unit 442 transmits the MAC address of the first access point 500 and the acquired self-location information to the location identification apparatus 600 in association with each other. It should be noted that the timing at which the transmission control unit 442 transmits information to the location identification apparatus 600 is not limited to this. For example, the transmission control unit 442 may transmit the MAC address and the self-location information to the location identification apparatus 600 at a timing when the self-location information changes.

The location identification apparatus 600 is an external apparatus that performs a process of identifying the locations of the package 200 and the package 210, and is, for example, an information processing device (server). The location identification apparatus 600 includes a communication unit 610, a storage unit 620, and a control unit 630. The communication unit 610 is a communication module for transmitting and receiving information to and from another apparatus. The communication unit 610 can communicate with the first device 300, the second device 310, the in-vehicle apparatus 400, and the base terminal 410 via, for example, wireless communication. The storage unit 620 is a storage medium including a ROM, a RAM, a hard disk, and the like. The storage unit 620 stores a program executed by the control unit 630.

The control unit 630 is a calculation resource including a processor such as a CPU. The control unit 630 implements functions of an acquisition unit 631, a storage control unit 632, and a transmission control unit 633 by executing the program stored in the storage unit 620. It should be noted that the control unit 630 may be implemented by an electronic circuit formed by a combination of one or more processors and electronic circuits.

The acquisition unit 631 is a second acquisition unit that acquires information from another apparatus via the communication unit 610. The acquisition unit 631 acquires the MAC address (the first identification information) acquired by the first device 300 and the device ID of the first device 300 from the first device 300. The acquisition unit 631 acquires the MAC address and the device ID each time the MAC address and the device ID are transmitted from the first device 300.

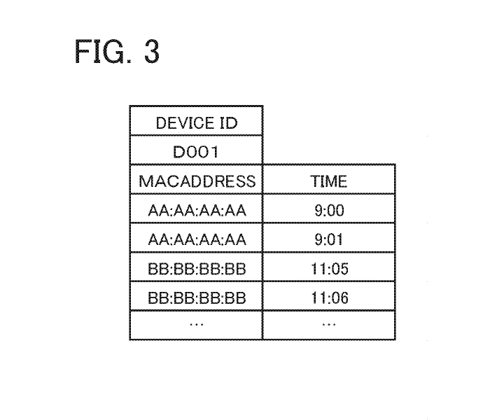

Each time the MAC address and the device ID are acquired from the first device 300, the acquisition unit 631 stores the acquired MAC address and device ID in the storage unit 620. FIG. 3 is an example of a data table in which a device ID and a MAC address are associated with each other. Device ID [D001] is a device ID of the first device 300 attached to the package 200. A MAC address of the data table of FIG. 3 is the MAC address (the first identification information) acquired by the first device 300. In the data table of FIG. 3, the MAC addresses acquired from the first device 300, which is indicated by device ID [D001], are associated with the times at which the MAC addresses were acquired.

The data table of FIG. 3 indicates that MAC address [AA:AA:AA:AA] was acquired at 9:00 and 9:01. The MAC address [AA:AA:AA:AA] is the MAC address of the first access point 500 mounted on the vehicle 100. The data table of FIG. 3 indicates that MAC address [BB:BB:BB:BB] was acquired at 11:05 and 11:06. The MAC address [BB:BB:BB:BB] is the MAC address of the second access point 510 installed at the delivery base K.

The acquisition unit 631 acquires a MAC address and self-location information from the in-vehicle apparatus 400. Each time (that is, every one minute) the MAC address [AA:AA:AA:AA] as the second identification information and the self-location information indicating the current position of the vehicle 100 are transmitted from the in-vehicle apparatus 400, the acquisition unit 631 acquires the MAC address [AA:AA:AA:AA] and the self-location information from the in-vehicle apparatus 400.

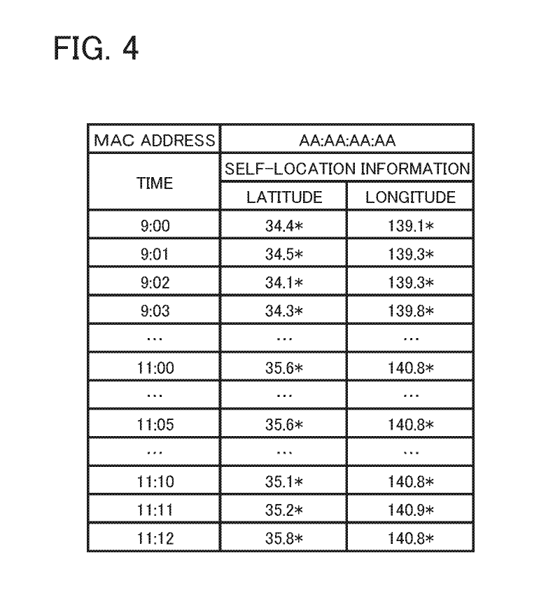

Upon each acquisition of the MAC address and the self-location information, the acquisition unit 631 stores the acquired self-location information and a time at which the self-location information is acquired in the storage unit 620 in association with the acquired MAC address. FIG. 4 is an example of a data table in which a MAC address and self-location information are associated with each other. In the data table of FIG. 4, the MAC address [AA:AA:AA:AA] is associated with (i) latitude and longitude representing self-location information indicating the current position of the vehicle 100 and (ii) time at which the self- location information was acquired. The position indicated by the self-location information associated with each time point corresponds to the position of the vehicle 100 at that time. It should be noted that the positions indicated by the self-location information associated with 11:00 and 11:05 correspond to the position of the delivery base K.

When the package 200 to which the first device 300 is attached is mounted on the vehicle 100, the acquisition unit 631 acquires a scheduled arrival time at which the vehicle 100 arrives at the destination of the package 200. For example, when a MAC address acquired from the first device 300 is the MAC address of the first access point 500 mounted on the vehicle 100, the acquisition unit 631 acquires the scheduled arrival time at which the vehicle 100 transporting the package 200, corresponding to the device ID, arrives at the destination. Specifically, by transmitting the acquired MAC address to the server that stores the operation of the vehicle 100, the acquisition unit 631 acquires the scheduled arrival time of the vehicle 100 that is equipped with the first access point 500 corresponding to the MAC address. The server stores, for example, the MAC address of the first access point 500 mounted on the vehicle 100 and the scheduled arrival time of the vehicle 100 in association with each other. The scheduled arrival time is set in advance based on factors such as the distance from the delivery base where the package 200 has been stored to the destination of the package 200, and is assumed here to be 11:00. In addition, the scheduled arrival time may be set according to the distance between the current position of the vehicle 100 and the delivery base K, which is the destination of the package 200.

The storage control unit 632 causes the storage unit 620 to store the position of the first device 300 on the basis of the acquired MAC address. When the MAC address (first identification information) transmitted from the first device 300 and the MAC address (second identification information) transmitted from the in-vehicle apparatus 400 are the same, the storage control unit 632 causes the storage unit 620 to store the current position of the vehicle 100 as the position of the first device 300. In other words, the storage control unit 632 causes the storage unit 620 to store, as the position of the first device 300, the current position of the vehicle 100 indicated by the self-location information associated with the second identification information having the same MAC address as the MAC address of the first identification information transmitted from the first device 300.

When self-location information indicating a new current position is acquired, the storage control unit 632 updates the position of the first device 300. For example, when self-location information indicating a new current position and a MAC address (second identification information) are acquired from the in-vehicle apparatus 400, the storage control unit 632 updates the position of the first device 300, which transmitted a MAC address (first identification information) identical to the acquired MAC address (second identification information), to the new current position. Specifically, the storage control unit 632 causes the storage unit 620 to store, in association with the device ID [D001] of the first device 300, (i) the latitude and longitude indicating the new current position, (ii) the time at which the new current position was acquired, and (iii) the MAC address (second identification information) associated with the self-location information indicating the new current position.

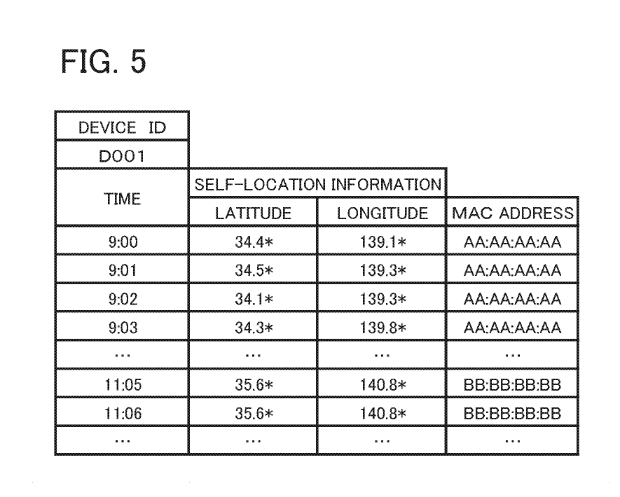

FIG. 5 is an example of a data table in which a device ID is associated with self-location information. In the data table of FIG. 5, the latitude and longitude as the self-location information and the time at which the self-location information was acquired are associated with the device ID. In this way, the storage control unit 632 causes the storage unit 620 to store, as the position of the first device 300, the position of the vehicle 100 on which the first access point 500 having the same MAC address as the MAC address transmitted from the first device 300 is mounted. With this configuration, the user who refers to the data table of FIG. 5 can identify when and where the package 200, to which the first device 300 is attached, was located. When the user wishes to check the location of the package 200, by connecting to the location identification apparatus 600 using a predetermined terminal and referring to the data table of FIG. 5, the user can grasp when and where the package 200 was located.

While the package 200 is mounted on the vehicle 100, the first device 300 continues to acquire the MAC address [AA:AA:AA:AA] of the first access point 500 mounted on the vehicle 100. When the acquisition unit 631 continues to acquire the MAC address [AA:AA:AA:AA] from the first device 300, the acquisition unit 631 does not need to acquire a new MAC address from the first device 300. In other words, while the package 200 is mounted on the vehicle 100, the first device 300 does not need to transmit any newly acquired MAC address to the location identification apparatus 600.

Therefore, while the same MAC address (first identification information) is being acquired from the first device 300, the transmission control unit 633 (third transmission control unit) of the location identification apparatus 600 transmits, to the first device 300, a transmission stop instruction for stopping transmission of the newly acquired MAC address to the location identification apparatus 600. Specifically, the transmission control unit 633 transmits the transmission stop instruction to the first device 300 after the position of the first access point 500 having the same MAC address as the MAC address transmitted by the first device 300 is stored as the position of the first device 300.

The acquisition unit 341 of the first device 300 acquires the transmission stop instruction output from the location identification apparatus 600. When the transmission stop instruction is acquired from the location identification apparatus 600, the transmission control unit 342 stops transmitting the newly acquired MAC address (first identification information) to the location identification apparatus 600 while the same MAC address (first identification information) is being acquired. As a specific example, when the transmission stop instruction is received from the location identification apparatus 600 after transmitting the MAC address [AA:AA:AA:AA], the transmission control unit 342 does not transmit the MAC address [AA:AA:AA:AA] to the location identification apparatus 600 even if the MAC address [AA:AA:AA:AA] is newly acquired. More specifically, after transmitting the MAC address [AA:AA:AA:AA], the transmission control unit 342 does not transmit the MAC address [AA:AA:AA:AA] to the location identification apparatus 600 while the same MAC address is continuously being acquired. In this way, the transmission control unit 342 can suppress unnecessary transmission of MAC addresses, thereby reducing power consumption related to transmission of MAC addresses.

When a MAC address (third identification information) is acquired from an access point that is different from the first access point 500 indicated by the acquired MAC address (first identification information), the transmission control unit 342 transmits a new MAC address (third identification information) to the location identification apparatus 600. In other words, when the new MAC address (third identification information) acquired after the transmission stop instruction is acquired from the location identification apparatus 600 differs from the acquired MAC address (first identification information), the transmission control unit 342 transmits the new MAC address (third identification information) to the location identification apparatus 600. The transmission control unit 342 transmits the new MAC address (third identification information) in association with the device ID (device identification information) to the location identification apparatus 600. It should be noted that the acquired MAC address (first identification information) is stored in the storage unit 330 of the first device 300 each time it is acquired.

The transmission control unit 342 of the first device 300 transmits the MAC address [AA:AA:AA:AA], which is acquired from the first access point 500, to the location identification apparatus 600 at 9:00 and 9:01. The transmission control unit 633 of the location identification apparatus 600 transmits a transmission stop instruction to the first device 300 upon successive acquisitions of the same MAC address [AA:AA:AA:AA] from the first device 300.

After the transmission stop instruction output from the location identification apparatus 600 is acquired, the transmission control unit 342 stops transmitting the MAC address [AA:AA:AA:AA] to the location identification apparatus 600 until a MAC address different from the MAC address [AA:AA:AA:AA] is acquired. In other words, while the MAC address [AA:AA:AA:AA] is being acquired, the transmission control unit 342 does not transmit the MAC address [AA:AA:AA:AA] to the location identification apparatus 600. Upon acquisition of the MAC address [BB:BB:BB:BB], which is different from the MAC address [AA:AA:AA:AA], at 11:05 (see FIG. 3), the transmission control unit 342 transmits the newly acquired MAC address [BB:BB:BB:BB] to the location identification apparatus 600. In this way, the transmission control unit 342 can suppress communication with the location identification apparatus 600 while the same MAC address [AA:AA:AA:AA] is being acquired, thereby reducing power consumption of the first device 300.

Meanwhile, since the acquisition unit 341 of the first device 300 does not acquire the MAC address different from the MAC address of the first access point 500 while the package 200 is mounted on the vehicle 100, it does not need to acquire any new MAC address. Therefore, the transmission control unit 633 of the location identification apparatus 600 transmits an acquisition stop instruction for stopping acquisition of a new MAC address to the first device 300 while the package 200 to which the first device 300 is attached is mounted on the vehicle 100. Hereinafter, a process flow of transmitting the acquisition stop instruction to the first device 300 when the package 200 is mounted on the vehicle 100 will be described.

The acquisition unit 631 of the location identification apparatus 600 determines whether a MAC address acquired from the first device 300 is the MAC address of the first access point 500 mounted on the vehicle 100. For example, the acquisition unit 631 determines, by referencing management information indicating whether the first access point 500 indicated by the MAC address is mounted on the vehicle 100, whether the MAC address acquired from the first device 300 corresponds to the MAC address of the first device 300 mounted on the vehicle 100. The management information associates the MAC address with information indicating whether the first access point 500 indicated by the MAC address is mounted on the vehicle 100. The management information is stored in the storage unit 620, for example.

When the MAC address acquired from the first device 300 corresponds to the MAC address of the first access point 500 mounted on the vehicle 100, the acquisition unit 631 determines that the package 200 is mounted on the vehicle 100. When the MAC address acquired from the first device 300 does not correspond to the MAC address of the first access point 500 mounted on the vehicle 100, the acquisition unit 631 determines that the package 200 is not mounted on the vehicle 100.

When the package 200 is mounted on the vehicle 100, the acquisition unit 631 acquires the scheduled arrival time at which the vehicle 100 arrives at the delivery base K, which is the destination of the package 200. For example, by transmitting the device ID of the first device 300 attached to the package 200 to an operation management server that manages the operation of the vehicle 100, the acquisition unit 631 acquires, from the server, the scheduled arrival time at which the vehicle 100 arrives at the delivery base K. The operation management server is a server that manages information in which (i) the device ID and (ii) the scheduled arrival time of the vehicle 100 transporting the package 200, to which the device ID is attached, to the delivery base K, are associated with each other. When receiving the device ID from the location identification apparatus 600, the operation management server transmits, to the location identification apparatus 600, the scheduled arrival time of the vehicle 100 transporting the package 200, corresponding to the device ID, to the delivery base K. After the scheduled arrival time is acquired, the transmission control unit 633 transmits, to the first device 300, an acquisition stop instruction to stop acquiring MAC addresses until the scheduled arrival time is reached.

When the acquisition stop instruction is received from the location identification apparatus 600, the acquisition unit 341 of the first device 300 stops the acquisition of the MAC address from the first access point 500 until the scheduled arrival time is reached. Specifically, the acquisition unit 341 stops the communication unit 320 upon receiving the acquisition stop instruction output from the location identification apparatus 600. More specifically, the acquisition unit 341 stops the operation of the communication unit 320 by stopping the supply of power to the communication unit 320 (communication module). By stopping the operation of the communication unit 320, the acquisition unit 341 stops receiving the MAC address transmitted from the first access point 500. Accordingly, the acquisition unit 341 can suppress unnecessary acquisition of MAC addresses, thereby reducing power consumption of the first device 300.

The acquisition unit 341 resumes acquisition of MAC addresses from the access point in response to the scheduled arrival time having passed. Specifically, after the scheduled arrival time has passed, by activating the communication unit 320, the acquisition unit 341 acquires a MAC address from an access point capable of wireless communication with the communication unit 320. More specifically, the acquisition unit 341 starts the operation of the communication unit 320 by resuming the supply of power to the communication unit 320 (communication module). With this configuration, the acquisition unit 341 can acquire the MAC address of the second access point 510 when the possibility arises that the MAC address of the second access point 510 at the delivery base K can be acquired as the package 200 arrives at the delivery base K.

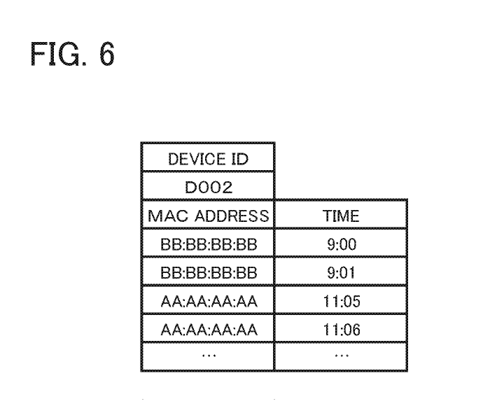

The position of the package 210 stored in the delivery base K does not change until the package 210 is shipped from the delivery base K. Therefore, the transmission control unit 633 of the location identification apparatus 600 transmits, to the second device 310, an acquisition stop instruction to stop acquiring MAC addresses until the package 210, to which the second device 310 is attached, is shipped from the delivery base K. Hereinafter, a process of transmitting the acquisition stop instruction to the second device 310 when the package 210 is stored at the delivery base K will be described with reference to FIG. 6.

FIG. 6 is a data table in which a MAC address is associated with a device ID. In the data table of FIG. 6, the MAC addresses and the times at which the MAC addresses were acquired are associated with device ID [D002] of the second device 310. The data table of FIG. 6 is stored in, for example, the storage unit 620.

It is assumed that the acquisition unit 631 acquires the MAC address [BB:BB:BB:BB] at 9:00 and 9:01. The acquisition unit 631 stores, in the storage unit 620, the acquired MAC address [BB:BB:BB:BB] and the times at which the MAC address [BB:BB:BB:BB] was acquired, in association with the device ID [D002] of the second device 310.

When the same MAC address is continuously transmitted from the second device 310, the acquisition unit 631 determines whether the MAC address acquired from the second device 310 corresponds to the MAC address of the second access point 510 installed at the delivery base K. For example, the acquisition unit 631 determines, by referencing the MAC address and the management information indicating whether the second access point 510 indicated by that MAC address is installed at the delivery base K, whether the MAC address acquired from the first device 300 corresponds to the MAC address of the second access point 510 installed at the delivery base K. The management information is stored in the storage unit 620, for example. When the MAC address acquired from the second device 310 corresponds to the MAC address of the second access point 510 installed at the delivery base K, the acquisition unit 631 determines that the package 210 is stored at the delivery base K. When the MAC address acquired from the second device 310 does not correspond to the address of the second access point 510 installed at the delivery base K, the acquisition unit 631 determines that the package 210 is not stored at the delivery base K.

When the package 210 is stored in the delivery base K, the acquisition unit 631 acquires a scheduled shipping time at which the package 210 is scheduled to be shipped from the delivery base K. By transmitting the device ID of the second device 310 attached to the package 210 to an operation management server that manages the operation of the vehicle 100 that is scheduled to transport the package 210, the acquisition unit 631 acquires the scheduled shipping time of the package 210 from the operation management server. After the scheduled

shipping time is acquired, the transmission control unit 633 transmits, to the second device 310, an acquisition stop instruction to stop acquiring MAC addresses until the scheduled shipping time is reached. It is assumed that the scheduled shipping time is 11:00. Specifically, the transmission control unit 633 transmits both the transmission stop instruction and the acquisition stop instruction to the second device 310.

When the acquisition stop instruction output from the location identification apparatus 600 is received, the acquisition unit 341 of the second device 310 stops the acquisition of the MAC address from the second access point 510 until the scheduled shipping time (11:00) is reached. Specifically, the acquisition unit 341 of the second device 310 stops the communication unit 320 of the second device 310 upon receiving the acquisition stop instruction output from the location identification apparatus 600. More specifically, the acquisition unit 341 stops the operation of the communication unit 320 by stopping the supply of power to the communication unit 320 (communication module). By stopping the operation of the communication unit 320, the acquisition unit 341 stops receiving the MAC address transmitted from the first access point 500. Accordingly, the acquisition unit 341 can suppress unnecessary acquisition of MAC addresses, thereby reducing power consumption of the first device 300.

The acquisition unit 341 of the second device 310 resumes acquisition of the MAC address from the access point in response to the scheduled shipping time (11:00) having passed. Specifically, after the scheduled shipping time (11:00) has passed, the acquisition unit 341 of the second device 310 activates the communication unit 320 of the second device 310. More specifically, the acquisition unit 341 starts the operation of the communication unit 320 by resuming the supply of power to the communication module. After the operation of the communication unit 320 is started, the acquisition unit 341 acquires a MAC address from an access point capable of wireless communication with the communication unit 320 of the second device 310. It is assumed that the acquisition unit 341 acquires the MAC address [BB:BB:BB:BB] between 11:00 and 11:04, and acquires the MAC address [AA:AA:AA:AA] at 11:05.

While the MAC address [BB:BB:BB:BB] acquired before the acquisition of the transmission stop instruction is still being held, the transmission control unit 342 of the second device 310 does not transmit the MAC address [BB:BB:BB:BB] to the location identification apparatus 600. In other words, even if the MAC address [BB:BB:BB:BB] is newly acquired, the transmission control unit 342 does not transmit the MAC address [BB:BB:BB:BB] to the location identification apparatus 600. Upon acquisition of the MAC address [AA:AA:AA:AA], which is different from the MAC address [BB:BB:BB:BB], the transmission control unit 342 associates the MAC address [AA:AA:AA:AA] with the device ID [D002] and transmits them to the location identification apparatus 600. The data table of FIG. 6 shows that the MAC address [AA:AA:AA:AA] was acquired at 11:05 in the location identification apparatus 600.

As described above, the acquisition unit 341 of the second device 310 can transmit the MAC address [AA:AA:AA:AA] of the first access point 500 in the cargo space of the vehicle 100 to the location identification apparatus 600 when the package 210 is mounted on the vehicle 100. As a result, when the package 210 is mounted on the vehicle 100, the location identification apparatus 600 can identify the location of the package 210 by treating the position of the vehicle 100 as the location of the package 210.

### Process of identifying location

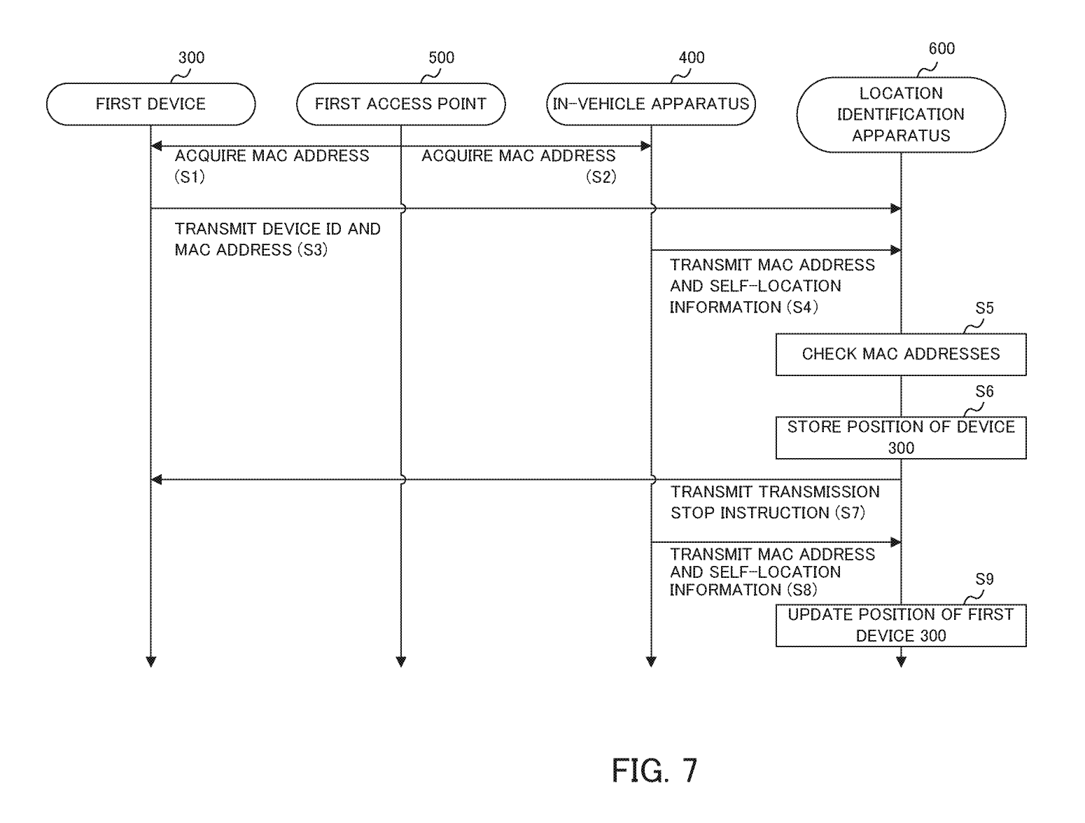

FIG. 7 is a sequence diagram illustrating a process flow of identifying a location of the package 200. In the process of identifying the location of the package 200, it is assumed that the acquisition unit 441 of the in-vehicle apparatus 400 acquires the current position of the vehicle 100 every one minute.

The first access point 500 transmits a MAC address of the first access point 500 to the

first device 300 and the in-vehicle apparatus 400. The acquisition unit 341 of the first device 300 acquires the MAC address transmitted by the first access point 500 (step S1). Specifically, the acquisition unit 341 acquires the MAC address of the first access point 500 as first identification information. The transmission control unit 442 of the in-vehicle apparatus 400 acquires the MAC address of the first access point 500 (step S2). Specifically, the transmission control unit 442 acquires the MAC address of the first access point 500 as second identification information.

The transmission control unit 342 of the first device 300 transmits a device ID and the MAC address to the location identification apparatus 600 (step S3). Specifically, the transmission control unit 342 transmits, in association with each other, (i) the MAC address of the first access point 500 acquired as the first identification information and (ii) the device ID (device identification information) of the first device 300 to the location identification apparatus 600.

The transmission control unit 442 of the in-vehicle apparatus 400 transmits the MAC address of the first access point 500 and self-location information to the location identification apparatus 600 (step S4). Specifically, the transmission control unit 442 transmits the MAC address of the first access point 500 acquired as the second identification information and the self-location information indicating the current position of the vehicle 100 to the location identification apparatus 600.

The location identification apparatus 600 checks the two transmitted MAC addresses (step S5). Specifically, the storage control unit 632 of the location identification apparatus 600 determines whether the MAC address transmitted as the first identification information from the first device 300 and the MAC address transmitted as the second identification information from the in-vehicle apparatus 400 are the same. When the MAC address transmitted from the first device 300 and the MAC address transmitted from the in-vehicle apparatus 400 are the same, the storage control unit 632 causes the storage unit 620 to store the position of the first device 300 (step S6). Specifically, the storage control unit 632 causes the storage unit 620 to store the current position indicated by the self-location information transmitted from the in-vehicle apparatus 400 as the current position of the first device 300.

After the current position of the first device 300 is stored in the storage unit 620, the transmission control unit 633 of the location identification apparatus 600 transmits a transmission stop instruction for MAC addresses to the first device 300 (step S7). Specifically, while the same MAC address is being acquired, the transmission control unit 633 transmits, to the first device 300, a transmission stop instruction for stopping transmission of the newly acquired MAC address (first identification information) to the location identification apparatus 600. When the transmission stop instruction output from the location identification apparatus 600 is received, the transmission control unit 342 of the first device 300 stops the transmission of the MAC address to the location identification apparatus 600 until a MAC address different from the transmitted MAC address is acquired.

The transmission control unit 442 of the in-vehicle apparatus 400 transmits the MAC address and the self-location information to the location identification apparatus 600 even after the transmission stop instruction is transmitted from the location identification apparatus 600 to the first device 300 (step S8). Upon each acquisition of the MAC address and the self-location information from the in-vehicle apparatus 400, the storage control unit 632 of the location identification apparatus 600 updates the position of the first device 300 stored in the storage unit 620 (step S9).

### Process of stopping acquisition of MAC Addresses

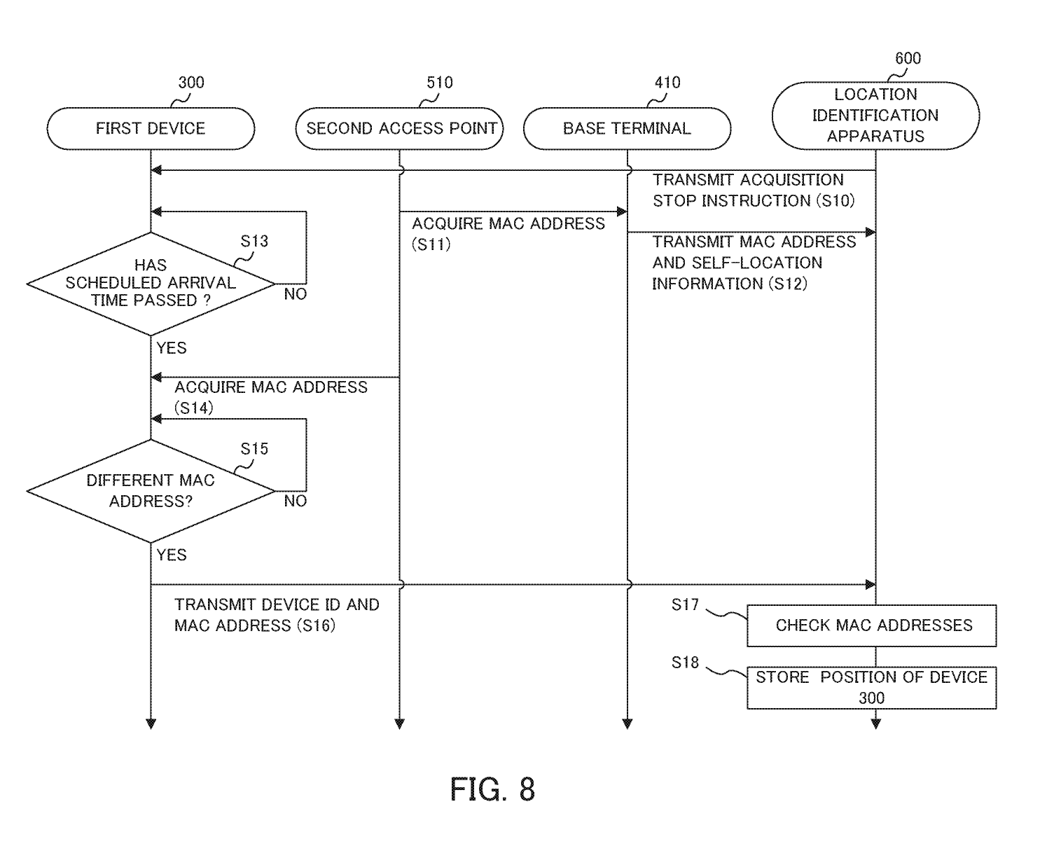

FIG. 8 is a sequence diagram illustrating a process of stopping acquisition of MAC addresses. The process of stopping the acquisition of MAC addresses is executed when the package 200, to which the first device 300 is attached, is mounted on the vehicle 100. Before the process of stopping the acquisition of MAC addresses is executed, it is assumed that the scheduled arrival time at which the vehicle 100 on which the package 200 is mounted arrives at the delivery base K, which is the destination, has been acquired.

The transmission control unit 633 of the location identification apparatus 600 transmits an acquisition stop instruction for MAC addresses to the first device 300 (step S10). Specifically, the transmission control unit 633 transmits, to the first device 300, an acquisition stop instruction to stop acquiring MAC addresses until the scheduled arrival time is reached. When the acquisition stop instruction output from the location identification apparatus 600 is received, the acquisition unit 341 of the first device 300 stops acquiring the MAC address from the access point (wireless device) capable of wireless communication with the first device 300.

The base terminal 410 acquires the MAC address of the second access point 510 from the second access point 510 of the delivery base K (step S11). Specifically, the transmission control unit 442 acquires the MAC address of the second access point 510 of the delivery base K as the second identification information. The base terminal 410 acquires self-location information indicating the position of the base terminal 410. The position of the base terminal 410 is the position of the delivery base K. The base terminal 410 transmits the acquired MAC address of the second access point 510 and the self-location information to the location identification apparatus 600 (step S12). Specifically, the base terminal 410 transmits the MAC address of the second access point 510 as the second identification information to the location identification apparatus 600 in association with the self-location information indicating the position of the delivery base K. It should be noted that the processes of step S11 and step S12 may be executed before step S10.

After the acquisition of the MAC address is stopped, the acquisition unit 341 determines whether the current time has passed the scheduled arrival time (step S13). If the current time has not passed the scheduled arrival time (No in step S13), the acquisition unit 341 waits until the current time passes the scheduled arrival time. If the current time has passed the scheduled arrival time (Yes in step S13), the acquisition unit 341 acquires the MAC address from the second access point 510 capable of wireless communication with the first device 300 (step S14). The second access point 510 is a wireless device installed at the delivery base K. The acquisition unit 341 acquires the MAC address of the second access point 510 as the first identification information.

The transmission control unit 342 of the first device 300 determines whether the acquired MAC address and a newly acquired MAC address are different MAC addresses (step S15). If the acquired MAC address and the newly acquired MAC address are the same (No in step S15), the transmission control unit 342 waits until a MAC address different from the acquired MAC address is acquired. If the acquired MAC address is different from the newly acquired MAC address (Yes in step S15), the transmission control unit 342 transmits the device ID and the MAC address of the first device 300 to the location identification apparatus 600 (step S16). Specifically, the transmission control unit 342 transmits the MAC address acquired from the second access point 510 as the first identification information to the location identification apparatus 600 in association with the device ID of the first device 300.

The storage control unit 632 of the location identification apparatus 600 checks the MAC addresses transmitted from the first device 300 (step S17). Specifically, the storage control unit 632 determines whether the MAC address transmitted from the first device 300 as the first identification information is the same as the MAC address transmitted from the base terminal 410. When the MAC address from the first device 300 and the MAC address from the base terminal 410 are the same, the storage control unit 632 causes the storage unit 630 to store the position of the delivery base K indicated by the self-location information associated with the MAC address of the base terminal 410 as the position of the first device 300 (step S18). Accordingly, the user who wishes to identify the location of the package 200 can grasp that the package 200 is at the delivery base K when the package 200 arrives at the delivery base K.

### Effects of the location identification system S

As described above, the location identification system S includes: the first device 300 attached to the package 200 transported by the vehicle 100; the in-vehicle apparatus 400 that transmits the self-location information indicating the current position; and the location identification apparatus 600 that acquires information from the first device 300 and the in-vehicle apparatus 400. The first device 300 transmits, as the first identification information, the MAC address acquired from the first access point 500 capable of wireless communication with the first device 300 to the location identification apparatus 600 in association with the device ID of the first device 300. The in-vehicle apparatus 400 transmits, as the second identification information, the MAC address acquired from the first access point 500 to the location identification apparatus 600 in association with the self-location information indicating the current position. The location identification apparatus 600 stores, as the position of the first device 300, the current position indicated by the self-location information associated with the MAC address that is the same as the MAC address from the first device 300. Accordingly, the location of the package 200 to which the first device 300 is attached can be identified.

When the MAC address from the first device 300 and the MAC address from the in-vehicle apparatus 400 are the same, the location identification apparatus 600 transmits a transmission stop instruction for stopping transmission of the MAC address to the first device 300. When the transmission stop instruction output from the location identification apparatus 600 is received, the first device 300 stops transmitting the MAC address to the location identification apparatus 600 while the same MAC address is being acquired. Accordingly, the first device 300 can suppress unnecessary transmission of MAC addresses, thereby reducing power consumption related to the transmission of MAC addresses.

After transmitting the transmission stop instruction to the first device 300, the location identification apparatus 600 can continue to acquire the current position from the in-vehicle apparatus 400. Each time the current position is acquired from the in-vehicle apparatus 400, the location identification apparatus 600 stores the acquired current position as the location of the package 200. Accordingly, the location identification apparatus 600 can identify the location of the package 200 to which the first device 300 is attached without communicating with the first device 300. As a result, the location identification system S can achieve both identification of the location of the package 200 to which the first device 300 is attached and reduction of power consumption of the first device 300.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Furthermore, new exemplary embodiments generated by arbitrary combinations of them are included in the exemplary embodiments. Furthermore, effects of the new exemplary embodiments brought by the combinations also have the effects of the original exemplary embodiments.

What is claimed is:

1. A location identification system comprising:
a device attached to a package transported by a vehicle;
a transmission apparatus that transmits self-location information; and
an external device that acquires information from the device and the transmission apparatus, wherein the device includes:
a first acquisition unit that acquires first identification information of one wireless device capable of wirelessly communicating with the device; and
a first transmission control unit that transmits the acquired first identification information and device identification information of the device to the external device in association with each other,
the transmission apparatus includes:
a second transmission control unit that transmits second identification information of one wireless device and the self-location information indicating a position associated with the one wireless device to the external device,
the external device includes:
a second acquisition unit that acquires the first identification information and the device identification information transmitted from the device, and the second identification information and the self-location information transmitted from the transmission apparatus;
a storage control unit that causes a storage unit to store a position indicated by the self-location information as a position of the device, when the first identification information and the second identification information are the same; and
a third transmission control unit that transmits, to the device, an instruction to stop the first transmission control unit from transmitting the first identification information acquired by the first acquisition unit to the external device, when the first identification information and the second identification information are the same, and
the first transmission control unit stops transmitting the first identification information to the external device when the instruction is received from the external device.

2. The location identification system according to claim 1, wherein the one wireless device indicated by the second identification information and the transmission apparatus are mounted on the vehicle transporting the package,
the transmission apparatus includes a third acquisition unit that acquires a current position of the transmission apparatus,
the second transmission control unit transmits, to the external device, (i) the self-location information indicating the current position acquired by the third acquisition unit and (ii) the second identification information, in association with each other, and
the storage control unit causes the storage unit to store the current position indicated by the self-location information as a position of the device indicated by the device identification information associated with the first identification information that is the same as the second identification information.

3. The location identification system according to claim 2, wherein the third acquisition unit acquires the current position at predetermined intervals,
the second transmission control unit transmits, upon each acquisition of the current position, the self-location information indicating the acquired current position and the second identification information to the external device, in association with each other, and
when the self-location information indicating a new current position and the second identification information are acquired, the storage control unit updates the position of the device associated with the first identification information that is the same as the second identification information to the new current position.

4. The location identification system according to claim 2, wherein the third transmission control unit transmits, to the device, an acquisition stop instruction for stopping acquisition of the first identification information, when the first identification information and the second identification information are the same and the one wireless device indicated by the second identification information is mounted on the vehicle, and
the first acquisition unit does not acquire the first identification information from the one wireless device mounted on the vehicle when the acquisition stop instruction is received from the external device.

5. The location identification system according to claim 1, wherein the device includes a wireless communication module that transmits and receives information to and from the one wireless device using wireless communication, and
the wireless communication module receives the first identification information transmitted by the one wireless device from the one wireless device.

6. The location identification system according to claim 4, wherein the device includes a wireless communication module that transmits and receives information to and from the one wireless device and the external device using wireless communication, and
the first acquisition unit does not acquire the first identification information from the one wireless device by stopping the wireless communication module when the acquisition stop instruction is received from the external device.

7. The location identification system according to claim 4, wherein the second acquisition unit acquires a scheduled time at which the vehicle arrives at a destination of the package,
the third transmission control unit transmits, to the device, the acquisition stop instruction for stopping acquisition of the first identification information until the scheduled time is reached, and
when the acquisition stop instruction is received from the external device, the first acquisition unit stops acquisition of the first identification information from the one wireless device mounted on the vehicle until the scheduled time is reached, and acquires the first identification information from the one wireless device in response to the scheduled time having passed.

8. The location identification system according to claim 7, wherein the device includes a wireless communication module that transmits and receives information to and from the one wireless device and the external device using wireless communication,
when the acquisition stop instruction is received from the external device, the first acquisition unit stops the wireless communication module until the scheduled time is reached, and activates the wireless communication module in response to the scheduled time having passed.

9. The location identification system according to claim 1, wherein the first transmission control unit transmits, to the external device, third identification information of one wireless device and the device identification information in association with each other when the third identification information newly acquired by the first acquisition unit after receiving the instruction from the external device differs from the first identification information.

10. The location identification system according to claim 1, wherein the second acquisition unit acquires a scheduled time at which the package is to be shipped from one facility, in which the package is stored, when the one wireless device corresponding to the second identification information that is the same as the first identification information is installed in the one facility, and
the third transmission control unit transmits, to the device, an acquisition stop instruction to stop acquisition of the first identification information until the scheduled time is reached, and
when the acquisition stop instruction is received from the external device, the first acquisition unit stops the acquisition of the first identification information from the one wireless device until the scheduled time is reached, and acquires the first identification information from the one wireless device in response to the scheduled time having passed.

11. The location identification system according to claim 10, wherein the device includes a wireless communication module that transmits and receives information to and from the one wireless device and the external device using wireless communication, and
when the acquisition stop instruction is received from the external device, the first acquisition unit stops the wireless communication module until the scheduled time is reached, and activates the wireless communication module in response to the scheduled time having passed.

12. A location identification apparatus comprising:
an acquisition unit that acquires, from a device attached to a package transported by a vehicle, (i) first identification information of one wireless device capable of wirelessly communicating with the device and (ii) device identification information of the device that transmits the first identification information and the device identification information in association with each other, and acquires second identification information of the one wireless device and self-location information indicating a position associated with the one wireless device from a transmission apparatus that transmits the second identification information and the self-location information;
a storage control unit that causes a storage unit to store a position indicated by the self-location information as a position of the device when the first identification information and the second identification information are the same; and
a transmission control unit that transmits, to the device, a stop instruction to stop transmission of the first identification information acquired by the acquisition unit when the first identification information and the second identification information are the same.

13. The location identification apparatus of claim 12, comprising:
a wireless communication module that transmits and receives information to and from the device and the transmission apparatus using wireless communication, wherein
the wireless communication module receives the first identification information and the device identification information from the device,
receives the second identification information and the self-location information from the transmission apparatus, and
transmits the stop instruction to the device under the control of the transmission control unit.
